(19) United States
(12) Patent Application Publication
(10) Pub. No.: US 2025/0380834 A1
(43) Pub. Date: Dec. 18, 2025

(54) NETWORK SYSTEM FOR TRANSMITTING AND RECEIVING COOKING INFORMATION

(71) Applicant: SAMSUNG ELECTRONICS CO., LTD., Suwon-si (KR)

(72) Inventors: Donghyun SOHN, Suwon-si (KR); Heungryong OH, Suwon-si (KR); Heekyung YANG, Suwon-si (KR); Jingeun PARK, Suwon-si (KR)

(73) Assignee: SAMSUNG ELECTRONICS CO., LTD., Suwon-si (KR)

(21) Appl. No.: 19/315,062

(22) Filed: Aug. 29, 2025

Related U.S. Application Data
(63) Continuation of application No. PCT/KR2024/095230, filed on Feb. 15, 2024.

(30) Foreign Application Priority Data
Mar. 31, 2023 (KR) 10-2023-0043209

(51) Int. Cl. A47J 36/32

(52) U.S. Cl. CPC A47J 36/321

(57) ABSTRACT

A virtual space server in a network system to receive a first signal to share cooking information from a first user terminal while providing a virtual space to the first user terminal. The virtual space server transmits the first signal to an IoT server, on the basis of having received the first signal. The IoT server in the network system may transmit, on the basis of the first signal, one or more second signals associated with the cooking information of the first signal to one or more second user terminals different from the first user terminal.

### CROSS-REFERENCE TO RELATED APPLICATIONS

This application is a continuation application, under 35 U.S.C. § 111(a), of International Patent Application No. PCT/KR2024/095230, filed on Feb. 15, 2024, which based on and claims benefit of priority under 35 U.S.C. § 119 to Korean Patent Applications No. 10-2023-0043209, filed on Mar. 31, 2023, in the Korean Intellectual Property Office, the disclosures of which are incorporated by reference herein in their entireties.

### TECHNICAL FIELD

The present disclosure relates to a network system for transmitting and receiving cooking information.

### BACKGROUND ART

To provide an enhanced user experience, an electronic device providing an augmented reality (AR) service that displays computer-generated information in conjunction with an external object in the real-world is being developed.

The above-described information may be provided as related art for the purpose of helping the understanding of the present disclosure. No claim or determination is raised as to whether any of the above-described content may be applied as prior art related to the present disclosure.

### DISCLOSURE

### Technical Solution

According to an embodiment, a network system may include a virtual space server for providing a virtual space, and an Internet of Things (IoT) server for communicating with a first user terminal. The virtual space server may receive a first signal for sharing cooking information from the first user terminal while providing the virtual space to the first user terminal. The virtual space server may transmit the first signal to the IoT server based on receiving the first signal. The IoT server may transmit one or more second signals associated with the cooking information of the first signal to one or more second user terminals, which are different from the first user terminal, based on the first signal.

According to an embodiment, an electronic device may comprise communication circuitry and a processor. The processor may receive, from a first external electronic device among a plurality of external electronic devices through the communication circuitry, selection information including first cooking information inputted to the first external electronic device and indication to control at least one second external electronic device among the plurality of external electronic devices. The processor may transmit, based on the first cooking information being changed to second cooking information, the second cooking information to the at least one second external electronic device based on the indication to control the at least one second external electronic device in the selection information.

According to an embodiment, an electronic device may comprise communication circuitry and a processor. The processor may transmit data for providing a virtual space to a plurality of external electronic devices through the communication circuitry. While providing the virtual space, the processor may receive, from a first external electronic device among the plurality of external electronic devices, selection information including first cooking information inputted to the first external electronic device indication to control at least one second external electronic device among the plurality of external electronic devices. The processor may change, based on model information of the at least one second external electronic device, the first cooking information to second cooking information. The processor may transmit the second cooking information to the at least one second external electronic device based on the indication to control the at least one second external electronic device in the selection information.

### DESCRIPTION OF THE DRAWINGS

FIG. 1A illustrates an example of a virtual space provided by one of electronic devices according to an embodiment.

FIG. 1B illustrates an example of block diagrams of electronic devices according to an embodiment.

FIG. 1C illustrates an example of block diagrams of electronic devices according to an embodiment.

FIG. 1D illustrates an example of block diagrams of electronic devices according to an embodiment.

FIG. 1E illustrates an example of block diagrams of electronic devices according to an embodiment.

FIG. 1F illustrates an example of block diagrams of electronic devices according to an embodiment.

FIG. 1G illustrates an example of block diagrams of electronic devices according to an embodiment.

FIG. 2A illustrates an example of a virtual space provided by one of electronic devices according to an embodiment.

FIG. 2B illustrates an example of information stored in a memory included in one of electronic devices according to an embodiment.

FIG. 3 illustrates an example of a user interface (UI) provided by one of electronic devices according to an embodiment.

FIG. 4 illustrates an example of information stored in a memory included in one of electronic devices according to an embodiment.

FIG. 5 illustrates an example of a signal flowchart of a network system according to an embodiment.

FIG. 6 illustrates an example of a flowchart of an operation of an electronic device according to an embodiment.

FIG. 7 illustrates an example of a flowchart of an operation of an electronic device according to an embodiment.

### MODE FOR INVENTION

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the first electronic device 101, the second electronic device 103, the first external electronic device 111, the second external electronic device 113, the third external electronic device 115, and the fourth external electronic device 117). For example, a processor (e.g., the processor 120) of the machine (e.g., the first electronic device 101, the second electronic device 103, the first external electronic device 111, the second external electronic device 113, the third external electronic device 115, and the fourth external electronic device 117) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

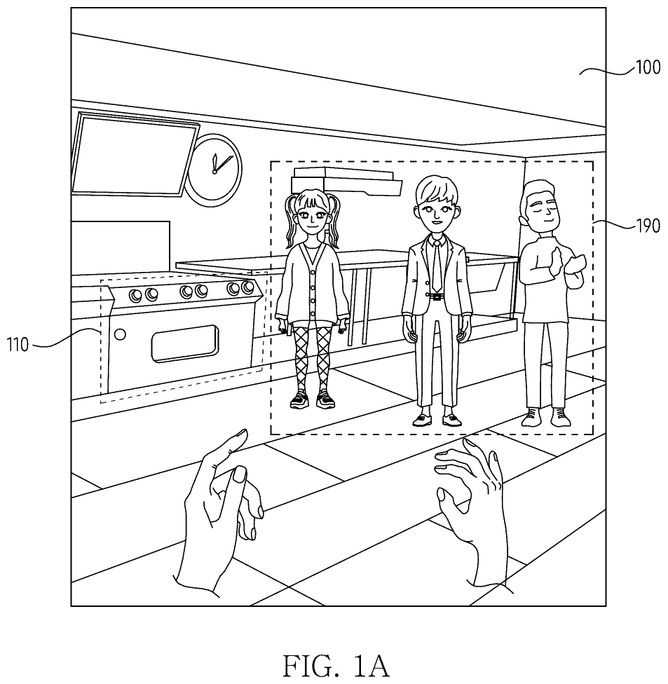

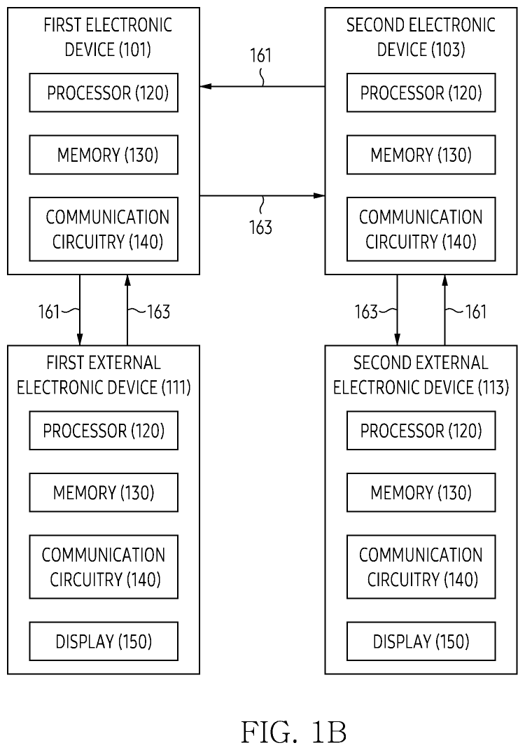

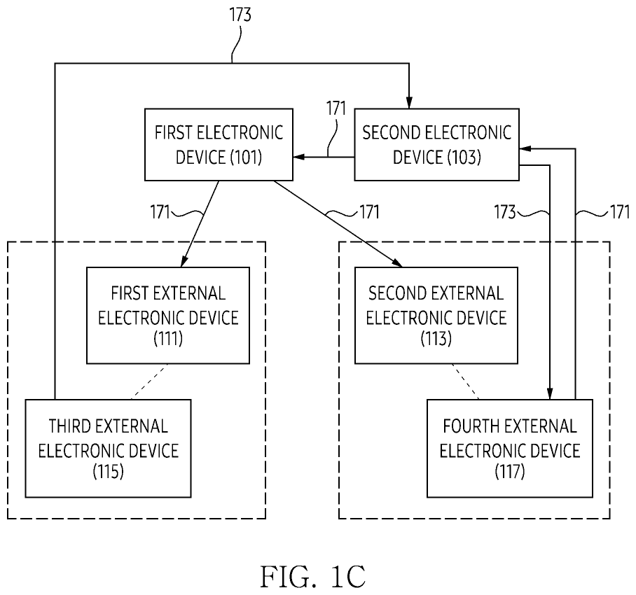

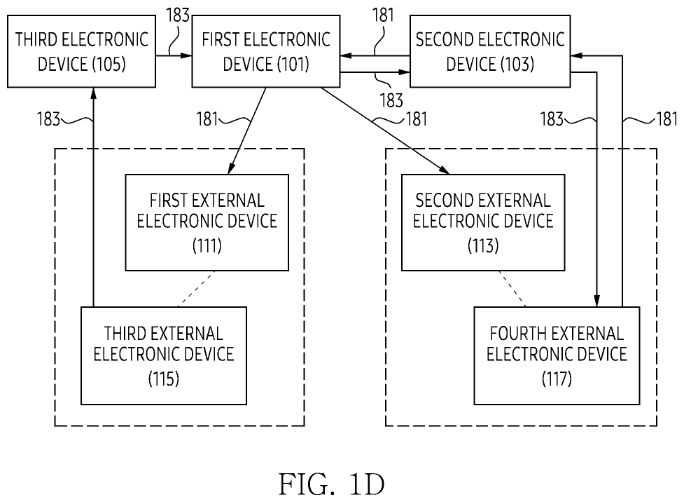

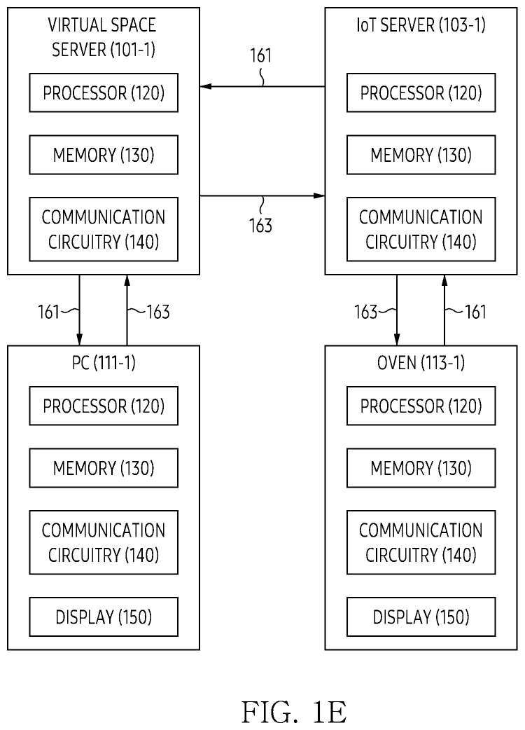

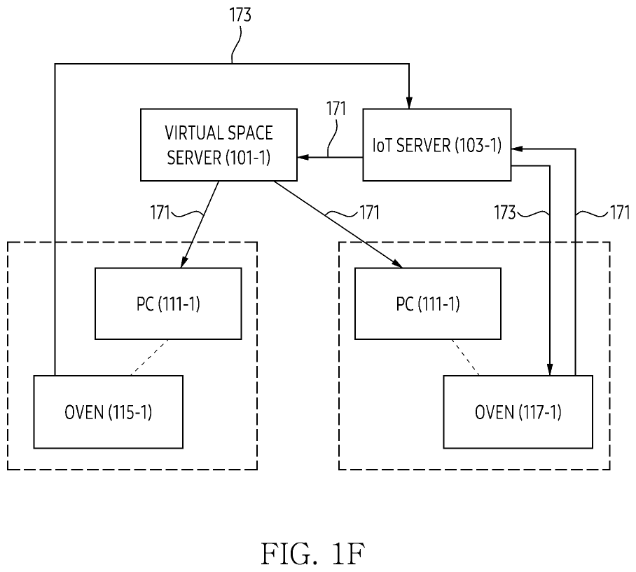

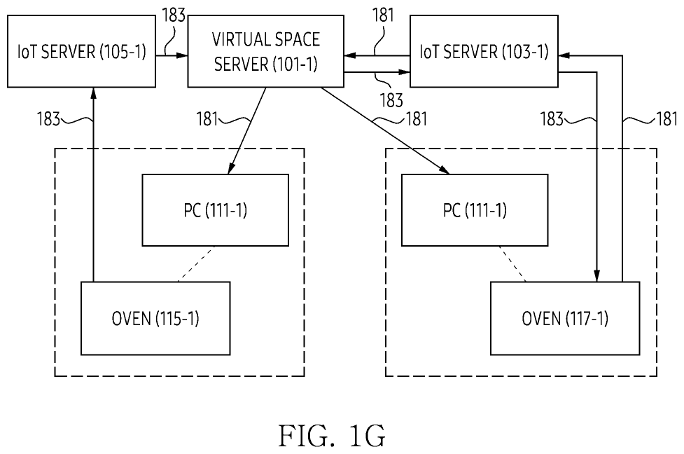

FIG. 1A illustrates an example of a virtual space provided by one of electronic devices according to an embodiment. FIG. 1B illustrates an example of block diagrams of electronic devices according to an embodiment. FIG. 1C illustrates an example of block diagrams of electronic devices according to an embodiment. FIG. 1D illustrates an example of block diagrams of electronic devices according to an embodiment. FIG. 1E illustrates an example of block diagrams of electronic devices according to an embodiment. FIG. 1F illustrates an example of block diagrams of electronic devices according to an embodiment. FIG. 1G illustrates an example of block diagrams of electronic devices according to an embodiment. Hereinafter, the electronic devices may include a first electronic device 101, a second electronic device 103, a first external electronic device 111, a second external electronic device 113, a third external electronic device 115, and/or a fourth external electronic device 117.

Referring to FIG. 1A, according to an embodiment, the first electronic device 101 may provide a virtual space 100 to electronic devices different from the first electronic device 101. For example, the virtual space 100 may include a virtual space for cooking food. For example, the electronic devices may cook a virtual dish using cooking utensils included in the virtual space. FIG. 1A may be an example of a virtual space provided by the first electronic device 101, which may be referred to as a virtual space server. For example, the virtual space may include a virtual space for providing a service such as a cooking class. For example, the first electronic device 101 may display virtual objects 190 corresponding to each of user terminals. For example, the virtual objects 190 may correspond to an avatar indicating a user. The virtual objects 190 may be represented based on a two-dimensional virtual coordinate system and/or a three-dimensional virtual coordinate system.

Referring to FIG. 1A, according to an embodiment, the first electronic device 101 may provide the virtual space 100. For example, the first electronic device 101 may transmit data for displaying a virtual object 110 in the virtual space 100 to electronic devices different from the first electronic device 101. For example, the virtual object 110 may include a virtual object for cooking food, such as an oven.

According to an embodiment, the first electronic device 101 may receive a signal for controlling the virtual object 110 from external electronic devices (e.g., the first external electronic device 111, the second external electronic device 113, the third external electronic device 115, and the fourth external electronic device 117). For example, the first electronic device 101 may receive, through communication circuitry 140, the signal for controlling the virtual object 110 from the external electronic devices with which a communication link has been established. The first electronic device 101 may receive the signal from the external electronic devices or may receive the signal through the second electronic device 103 different from the first electronic device 101. For example, the second electronic device 103 may be referred to as an Internet of Things (IoT) server. For example, the second electronic device 103 may be updated by an engineer and/or developer.

According to an embodiment, the first electronic device 101 may receive a signal including an input for the virtual object 110 while providing the virtual space 100. The first electronic device 101 may transmit a signal for displaying a visual object for controlling the virtual object 110 to the external electronic devices based on receiving the input for the virtual object 110. For example, the first electronic device 101 may transmit the signal for displaying the visual object for controlling the virtual object 110 to the external electronic devices through the second electronic device 103. For example, the visual object may include a visual object for inputting cooking information. The cooking information may include weight of a virtual object corresponding to a food ingredient included in the virtual object 110, a time to operate the virtual object 110, and/or a time to cook the food ingredient by the virtual object 110. For example, the cooking information may be referred to as a cooking recipe. The first electronic device 101 may receive the cooking information. For example, the first electronic device 101 may receive the cooking information from the first external electronic device 111. The first electronic device 101 may transmit the cooking information to the second electronic device 103 based on receiving the cooking information. The second electronic device 103 that has received the cooking information may transmit the cooking information to the second external electronic device 113 and/or the fourth external electronic device 117. The second external electronic device 113 and/or the fourth external electronic device 117 that has received the cooking information may operate based on the cooking information. For example, the second external electronic device 113 and/or the fourth external electronic device 117 may operate based on temperature information and/or time information included in the cooking information.

For example, the above-described virtual object 110 may include a visual object corresponding to an external object in an image obtained by a camera of the first external electronic device 111. For example, the first external electronic device 111 may display the visual object corresponding to the external object in at least a portion of the virtual space 100. For example, the first external electronic device 111 may receive cooking information inputted to the external object. For example, the first external electronic device 111 may transmit the cooking information inputted to the external object to the first electronic device 101.

FIG. 1B may be an example illustrating a portion of hardware components included in the electronic devices (e.g., the first electronic device 101 and the second electronic device 103) and/or the external electronic devices (e.g., the first external electronic device 111 and/or the second external electronic device 113). A third electronic device 105 described below may include a hardware component substantially identical to that of the first electronic device 101 and/or the second electronic device 103. The first electronic device 101 of FIG. 1B may include a virtual space server 101-1 of FIG. 1E. The virtual space server 101-1 of FIG. 1E may be provided based on a two-dimensional virtual coordinate system and/or a three-dimensional virtual coordinate system. The second electronic device 103 of FIG. 1B may include an IoT server 103-1 of FIG. 1E. For example, the IoT server 103-1 may be connected to home appliances such as an oven. The first external electronic device 111 of FIG. 1B may include a personal device such as a personal computer (PC) 111-1 of FIG. 1E. Although illustrated as the PC 111-1 in FIG. 1E, it may include a mobile phone and/or a head-mounted display (HMD). The second external electronic device 113 of FIG. 1B may include an oven 113-1 of FIG. 1E. Although illustrated as the oven 113-1 in FIG. 1E, it is not limited thereto. For example, the oven 113-1 of FIG. 1E may include home appliances used for cooking, such as a mixer, an air fryer, and/or a microwave.

Hereinafter, the electronic devices may include the first electronic device 101, the second electronic device 103, the third electronic device 105, the first external electronic device 111, the second external electronic device 113, the third external electronic device 115, and/or the fourth external electronic device 117.

According to an embodiment, each of the electronic devices may include at least one of a processor 120, a memory 130, the communication circuitry 140, or a display 150. The processor 120, the memory 130, the communication circuitry 140, and the display 150 may be electronically and/or operably coupled with each other by an electronical component such as a communication bus. Hereinafter, hardware being operably coupled may mean that a direct connection or an indirect connection between the hardware is established, wired or wireless, such that second hardware is controlled by first hardware among the hardware. Although illustrated in different blocks, an embodiment is not limited thereto. A portion of hardware of FIG. 1B may be included in a single integrated circuit such as a system on a chip (SoC). A type and/or the number of hardware included in the electronic devices is not limited to those illustrated in FIG. 1B. For example, each of the electronic devices may include only a portion of the hardware illustrated in FIG. 1B.

According to an embodiment, the processor 120 of each of the electronic devices may include hardware for processing data based on one or more instructions. The hardware for processing data may include the processor 120. For example, the hardware for processing data may include an arithmetic and logic unit (ALU), a floating point unit (FPU), a field programmable gate array (FPGA), a central processing unit (CPU), and/or an application processor (AP). The processor 120 may have a structure of a single-core processor, or may have a structure of a multi-core processor such as a dual core, a quad core, a hexa core, or an octa core.

According to an embodiment, the memory 130 of each of the electronic devices may include a hardware component for storing data and/or instructions inputted to and/or outputted from the processor 120 of each of the electronic devices. For example, the memory 130 may include volatile memory such as random-access memory (RAM), and/or non-volatile memory such as read-only memory (ROM). For example, the volatile memory may include at least one of dynamic RAM (DRAM), static RAM (SRAM), cache RAM, and pseudo SRAM (PSRAM). For example, the non-volatile memory may include at least one of programmable ROM (PROM), erasable PROM (EPROM), electrically erasable PROM (EEPROM), flash memory, hard disk, compact disk, solid state drive (SSD), and embedded multi-media card (eMMC).

According to an embodiment, the communication circuitry 140 of each of the electronic devices may include a hardware component for supporting transmission and/or reception of an electrical signal (or data) between each of the electronic devices. For example, the communication circuitry 140 may include at least one of a modem, an antenna, and an optical/electronic (O/E) converter. The communication circuitry 140 may support the transmission and/or reception of an electrical signal (or data) based on various types of protocols, such as Ethernet, a local area network (LAN), a wide area network (WAN), wireless fidelity (WiFi), Bluetooth, Bluetooth low energy (BLE), Zigbee, a long term evolution (LTE), and/or 5G new radio (NR).

According to an embodiment, the display 150 of each of the electronic devices may output visualized information to a user. For example, the display 150 may be controlled by the processor 120 including a circuit such as a graphic processing unit (GPU) to output visualized information to the user. The display 150 may include a flat panel display (FPD) and/or electronic paper. The FPD may include a liquid crystal display (LCD), a plasma display panel (PDP), and/or one or more light emitting diodes (LEDs). The LED may include an organic LED (OLED).

According to an embodiment, the display 150 of each of the electronic devices may include a sensor (e.g., a touch sensor panel (TSP)) for detecting an external object (e.g., a user's finger) on the display 150. For example, based on the TSP, each of the electronic devices may detect an external object that is in contact with the display 150 or floating on the display 150.

Referring to FIG. 1B, according to an embodiment, a network system may include the first electronic device 101, the second electronic device 103, the first external electronic device 111, and/or the second external electronic device 113. The first electronic device 101 may be referred to as a server for providing a virtual space. The second electronic device 103 may be referred to as a server for providing IoT. The first external electronic device 111 may be referred to as a wearable device such as a head mounted display (HMD) and/or an AR glass. The second external electronic device 113 may be referred to as a home appliance such as an oven and/or a wearable device. However, it is not limited thereto.

According to an embodiment, the first electronic device 101 may provide a virtual space to a plurality of external electronic devices (e.g., the first external electronic device 111 and the second external electronic device 113). The virtual space may include a virtual space such as a kitchen for cooking. The first electronic device 101 may receive a first signal 163 for sharing cooking information from the first external electronic device 111 among the plurality of external electronic devices while providing the virtual space. For example, the cooking information may include information associated with weight of a food ingredient, a time to control the second external electronic device 113, and/or an operation mode of the second external electronic device 113. For example, the first signal 163 may include a signal indicating selection of one or more external electronic devices among the plurality of external electronic devices. The first electronic device 101 may transmit the first signal 163 to the second electronic device 103 based on receiving the first signal 163. For example, the first electronic device 101 may transmit the first signal 163 to the second electronic device 103, with information shown in Table 1 below included in the first signal 163.

TABLE 1

| IP address of the | | Weight | | |
|---|---|---|---|---|
| first electronic | Chef | of Food | Cooking | Cooking |
| device 101 | Information | Ingredient | Time | Temperature |
| 111.111.11.1 | First user | 150 g | 10 minutes | 150° C. |

Referring to Table 1, for example, the first signal 163 may include an internet protocol (IP) address of the first electronic device 101. For example, the first signal 163 may include chef information. For example, the chef information may include information associated with a user of the first external electronic device 111. For example, the first signal 163 may include weight of a food ingredient. For example, the first signal 163 may include a cooking time. The cooking time may mean a time for cooking food. For example, the first signal 163 may include a cooking temperature. For example, the cooking temperature may include a temperature set by the second external electronic device 113. According to an embodiment, the second electronic device 103 may transmit the cooking information to one or more second external electronic devices identified among the plurality of external electronic devices based on the first signal 163 received from the first electronic device 101. Hereinafter, description is made with the second external electronic device 113, but the number of the second external electronic devices 113 is not limited. The second electronic device 103 may transmit a second signal 165 associated with the cooking information of the first signal 163 to the second external electronic device 115. The second external electronic device 113 that has received the second signal may operate based on cooking information and/or control information included in the second signal 165. For example, the control information may include information substantially identical to the information included in the cooking information.

According to an embodiment, the second external electronic device 113 may transmit a third signal 161 including model information, capability information, and/or state information to the second electronic device 103. For example, the model information may include a category of the second external electronic device 113. The model information may include a model name of the second external electronic device 113. The model information may include power information of the second external electronic device 113. For example, the state information may include information for notifying a usage state of the second external electronic device 113. For example, the state information may include information associated with whether the second external electronic device 113 is operating. For example, the capability information may include the power information of the second external electronic device 113.

According to an embodiment, the second electronic device 103 may transmit the third signal 161 to the first electronic device 101 based on receiving the third signal 161. The first electronic device 101 may transmit the third signal 161 to the first external electronic device 111 based on receiving the third signal 161. The first external electronic device 111 that has received the third signal 161 may change the cooking information included in the first signal 163 based on the state information and/or the model information included in the third signal 161. The first external electronic device 111 may transmit the first signal 163 including the changed cooking information to the second external electronic device 113 through the first electronic device 101 and the second electronic device 103.

According to an embodiment, the second electronic device 103 may transmit the third signal 161 to the first electronic device 101 based on receiving the third signal 161. The first electronic device 101 may transmit the third signal 161 to the first external electronic device 111 based on receiving the third signal 161. The first electronic device 101 may change the cooking information included in the first signal 163 based on the third signal 161. The first electronic device 101 may transmit the changed cooking information to the second external electronic device 113 through the second electronic device 103.

According to an embodiment, the second electronic device 103 may change the cooking information included in the first signal 163 based on receiving the third signal 161. The second electronic device 103 may transmit the first signal 163 including the changed cooking information to the second external electronic device 113.

As described above, each of the electronic devices may change the cooking information based on the state information and/or model information transmitted from the second external electronic device 113. Each of the electronic devices may perform an operation substantially identical to that of the first external electronic device 111 in the second external electronic device 113 different from the first external electronic device 111 by transmitting the changed cooking information based on the state information and/or model information of the second external electronic device 113 to the second external electronic device 113.

In FIG. 1C, the third external electronic device 115 may be referred to as a home appliance such as an oven. In FIG. 1C, the first external electronic device 111 may be referred to as a wearable device. In FIG. 1C, the second external electronic device 113 may be referred to as a wearable device. In FIG. 1C, the fourth external electronic device 117 may be referred to as a home appliance such as an oven. For example, the first external electronic device 111 and the third external electronic device 115 may be included in a first user terminal. For example, the second external electronic device 113 and the fourth external electronic device 117 may be included in a second user terminal.

Referring to FIG. 1C, according to an embodiment, the third external electronic device 115 may transmit a first signal 173 including cooking information and/or selection information to the second electronic device 103. For example, the selection information may include information associated with the fourth external electronic device 117 among the plurality of external electronic devices that is to receive the first signal 173. The first external electronic device 111 and the third external electronic device 115 may establish a communication link based on short-range wireless communication. The first external electronic device 111 may receive a third signal 171 transmitted from the first electronic device 101. The first external electronic device 111 may broadcast (or share) the third signal 171 transmitted from the first electronic device 101 to the third external electronic device 115. The third signal 171 may include state information and/or model information of the fourth external electronic device 117. For example, the third signal 171 may be transmitted from the fourth external electronic device 117 to the first electronic device 101 through the second electronic device 103. The second electronic device 103 may identify the model information of the fourth external electronic device 117 based on the third signal 171. The first electronic device 101 may transmit the third signal 171 to the first external electronic device 111 and/or the second external electronic device 113.

According to an embodiment, the third external electronic device 115 may transmit the first signal 173 including the cooking information and/or the selection information to the second electronic device 103. The second electronic device 103 may transmit the first signal 173 to the fourth external electronic device 117. For example, the second electronic device 103 may change the cooking information included in the first signal 173 based on identifying the model information of the fourth external electronic device 117 using the third signal 171. The second electronic device 103 may transmit the first signal 173 including the changed cooking information to the fourth external electronic device 117. The fourth external electronic device 117 may execute at least one function associated with the cooking information based on reception of the first signal 173 including the changed cooking information. For example, in a case in which the third external electronic device 115 has an output of 1000 watt (W) and the fourth external electronic device 117 has an output of 700 W, the second electronic device 103 may increase a cooking time included in the cooking information.

In FIG. 1D, the first electronic device 101, the second electronic device 103, and/or the third electronic device 105 may be referred to as a server. For example, the first electronic device 101 may be referred to as a metaverse server for providing a virtual space. For example, the second electronic device 103 may be referred to as an IoT server. For example, the third electronic device 105 may be referred to as an IoT server. The first external electronic device 111 may establish a communication link with the third external electronic device 115 based on short-range wireless communication. The second external electronic device 113 may establish a communication link with the fourth external electronic device 117 based on short-range wireless communication. The first electronic device 101 of FIG. 1D may include a virtual space server 101-1 of FIG. 1G. The second electronic device 103 of FIG. 1D may include an IoT server 103-1 of FIG. 1G. The third electronic device 105 of FIG. 1D may include an IoT server 105-1 of FIG. 1G. The first external electronic device 111 of FIG. 1D may include a PC 111-1 of FIG. 1G. The second external electronic device 113 of FIG. 1D may include a PC 113-1 of FIG. 1G. The third external electronic device 115 of FIG. 1D may include an oven 115-1 of FIG. 1G. The fourth external electronic device 117 of FIG. 1D may include an oven 117-1 of FIG. 1G. The PC 111-1 and/or the PC 113-1 illustrated in FIG. 1G is an example of a user terminal, and is not limited thereto. The oven 115-1 and/or the oven 117-1 illustrated in FIG. 1G is an example of a home appliance used for cooking, and is not limited thereto.

According to an embodiment, the first electronic device 101 may provide a virtual space to the first external electronic device 111 and/or the second external electronic device 113. The first electronic device 101 may receive a signal from the second electronic device 103 and the third electronic device 105 while providing the virtual space. For example, the first electronic device 101 may receive a first signal 183 transmitted from the third external electronic device 115 through the third electronic device 105.

According to an embodiment, the first external electronic device 111 may input cooking information using a virtual object in the virtual space. The first external electronic device 111 may transmit the cooking information to the third external electronic device 115. The third external electronic device 115 may transmit the first signal 183 including the cooking information to the third electronic device 105 based on receiving the cooking information from the first external electronic device 111. The third electronic device 105 may transmit the first signal 183 to the first electronic device 101 based on receiving the first signal 183 including the cooking information. The first electronic device 101 may transmit the first signal 183 to the fourth external electronic device 117 through the second electronic device 103. The fourth external electronic device 117 may execute at least one function associated with the cooking information based on receiving the first signal including the cooking information.

According to an embodiment, the fourth external electronic device 117 may transmit a third signal 181 including model information and/or state information to the second electronic device 103. The second electronic device 103 may transmit the third signal 181 to the first electronic device 101 based on receiving the third signal 181. The first electronic device 101 may transmit the third signal 181 to the first external electronic device 111 and/or the second external electronic device 113 based on receiving the third signal 181. The first external electronic device 111 may identify the model information and/or the state information of the fourth external electronic device 117 based on receiving the third signal 181. The second external electronic device 113 may identify the model information and/or the state information of the fourth external electronic device 117 based on receiving the third signal 181.

According to an embodiment, the first electronic device 101, the second electronic device 103, and/or the third electronic device 105 may change the cooking information based on the model information and/or the state information of the fourth external electronic device 117. Hereinafter, the first electronic device 101, the second electronic device 103, and/or the third electronic device 105 may be referred to as electronic devices. According to an embodiment, the electronic devices may identify whether to transmit the first signal 183 based on the state information included in the third signal 181. For example, in a case in which the fourth external electronic device 117 is operating, the electronic devices may at least temporarily cease transmission of the first signal 183. For example, in a case in which the fourth external electronic device 117 is not operating, the electronic devices may transmit the first signal 183 to the fourth external electronic device 117.

For example, the electronic devices may change first cooking information included in the first signal 183 to second cooking information. For example, the electronic devices may change the first cooking information to the second cooking information based on capability information and/or cooking information of the fourth external electronic device 117. For example, in a case in which the third external electronic device 115 has an output of 1000 watt (W) and the fourth external electronic device 117 has an output of 700 W, the electronic devices may increase a cooking time included in the first cooking information. The electronic devices may transmit the first signal 183 including the second cooking information to the fourth external electronic device 117 based on obtaining the second cooking information with the increased cooking time.

The above-described first signal 161, first signal 171, first signal 181, and second signal 165 may be substantially the same signals. The above-described third signal 163, third signal 173, and third signal 183 may be substantially the same signals.

In FIGS. 1B to 1D, the first electronic device 101, such as a server providing a virtual space, and the second electronic device 103, such as an IoT server, are illustrated separately, but an embodiment is not limited thereto. For example, the first electronic device 101 and the second electronic device 103 may be implemented as a single server.

As described above, according to an embodiment, the electronic devices may receive cooking information, state information, model information, and/or capability information from external electronic devices. The electronic devices may change the cooking information based on state information, model information, and/or capability information of an external electronic device. The electronic devices may transmit the changed cooking information to the external electronic device. The electronic devices may enhance user experience of the external electronic devices by providing the changed cooking information to the external electronic devices. For example, the electronic devices may provide an environment in which a user of the external electronic devices can use the devices without changing the cooking information.

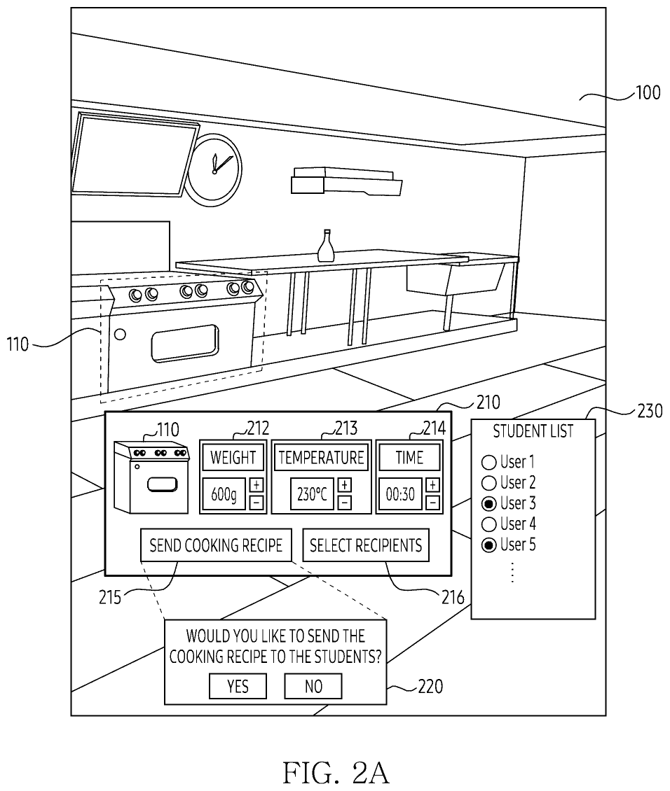

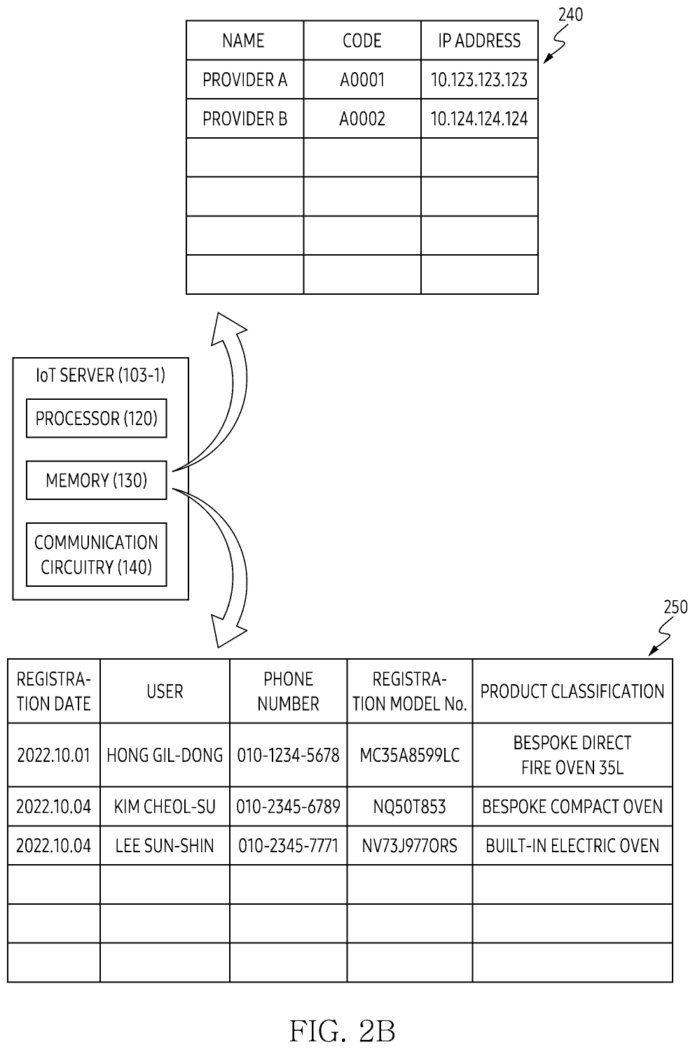

FIG. 2A illustrates an example of a virtual space provided by one of electronic devices according to an embodiment.

Referring to FIG. 2A, according to an embodiment, a first electronic device 101 may provide a virtual space 100 to external electronic devices (e.g., a first external electronic device 111 and a second external electronic device 113). The external electronic devices may display the virtual space 100 through a display. In FIG. 2A, an example of a screen displayed by the first external electronic device 111 is described.

Referring to FIG. 2A, the first external electronic device 111 may display the virtual space 100 through a display. The first external electronic device 111 may identify a virtual object 110 in the virtual space 100. The first external electronic device 111 may receive an input for the virtual object 110. For example, the first external electronic device 111 may receive an input selecting the virtual object 110.

According to an embodiment, the first external electronic device 111 may display a visual object 210 based on receiving the input selecting the virtual object 110. For example, the visual object 210 may be a visual object for setting cooking information. For example, the visual object 210 may include an image indicating a third external electronic device 115 linked with the first external electronic device 111. For example, the visual object 210 may include a first text field 212 for setting weight of food ingredients to be cooked by the third external electronic device 115. For example, the visual object 210 may include a second text field 213 associated with a temperature of the third external electronic device 115. For example, the visual object 210 may include a third text field 214 associated with a time for the third external electronic device 115 to operate. The first external electronic device 111 may identify a text input for the text fields. The first external electronic device 111 may set the cooking information based on the text input.

For example, the first external electronic device 111 may include visual objects for adjusting the increase or decrease of a value to be set, such as ‘+’ and/or ‘−’, in each of the text fields. The first external electronic device 111 may adjust the value to be set in each of the text fields based on an input for the visual objects.

For example, the visual object 210 may include a first button 216 for selecting external electronic devices that receive the cooking information. The first external electronic device 111 may identify an input for the first button 216. The first external electronic device 111 may display a list 230 indicating each of the users corresponding to each of the external electronic devices based on identifying the input selecting the first button 216. For example, the list 230 may include an ID (or a nickname) indicating each of the users. For example, the list 230 may include a check box indicating that each of the users has been selected. The check box may be activated when inputted in a deactivated state. The check box may be deactivated when inputted in an activated state. The first external electronic device 111 may transmit selection information indicating each of the users identified as being in the activated state to the first electronic device 101. For example, the first external electronic device 111 may identify an input for a second button 215 for transmitting the cooking information. The first external electronic device 111 may display a visual object 220 for determining the transmission to the first electronic device 101 based on the input for the second button 215. The first external electronic device 111 may transmit a signal including the cooking information and/or the selection information to the first electronic device 101 based on an input for a button (e.g., ‘YES’ button) that accepts the transmission, in the visual object 220. The first external electronic device 111 may at least temporarily cease the transmission of the signal including the cooking information and/or the selection information to the first electronic device 101 based on an input for a button (e.g., ‘NO’ button) that refuses the transmission, in the visual object 220.

As described above, according to an embodiment, the first external electronic device 111 may display the visual object 210 for setting the cooking information. The first external electronic device 111 may transmit the cooking information and/or the selection information to the first electronic device 101 based on setting the cooking information. The first external electronic device 111 and/or the first electronic device 101 may transmit the cooking information to each of the external electronic devices based on the cooking information and/or the selection information. Each of the external electronic devices that has received the cooking information may perform an operation associated with the cooking information. Each of the users of each of the external electronic devices may enhance user experience by receiving a service based on the cooking information.

FIG. 2B illustrates an example of information stored in a memory included in one of electronic devices according to an embodiment.

Referring to FIG. 2B, according to an embodiment, a second electronic device 103 may store a first list 240 and/or a second list 250 in a memory 130. For example, the first list 240 and/or the second list 250 may include information associated with each of the external electronic devices.

For example, the second electronic device 103 may store the first list 240 associated with the first electronic device 101. For example, the second electronic device 103 may include information associated with each of the first electronic devices from the plurality of first electronic devices. The first electronic device 101 may transmit information including a name, a code, and an internet protocol (IP) address of the first electronic device 101. The second electronic device 103 may identify information corresponding to the first electronic device 101 in the first list 240. The second electronic device 103 may identify whether the first electronic device 101 that has transmitted the cooking information is included in the first list 240. In a case in which the first electronic device 101 is included in the first list 240, the second electronic device 103 may transmit the cooking information received from the first electronic device 101 to the external electronic devices.

For example, the second electronic device 103 may identify information associated with the first electronic device 101 corresponding to provider A. For example, the second electronic device 103 may compare the first list 240 by loading it based on receiving the cooking information from the first electronic device 101 corresponding to provider A. The second electronic device 103 may transmit a first signal to the external electronic devices based on a name of provider A, a code (e.g., A0001) corresponding to provider A, and/or an IP address (e.g., 10.123.123.123) of provider A, included in the first list 240, matching the electronic device to which the first signal was transmitted.

According to an embodiment, the second electronic device 103 may store the second list 250. For example, the second list 250 may include information associated with the second external electronic device 113 and/or information associated with a fourth external electronic device 117. For example, the information associated with the second external electronic device 113 may include a date on which the second external electronic device 113 was registered in the second electronic device 103. For example, the information associated with the second external electronic device 113 may include a name of a user and/or a nickname of the user of the second external electronic device 113. For example, the information associated with the second external electronic device 113 may include a phone number of the user. For example, the information associated with the second external electronic device 113 may include model information of the fourth external electronic device 117 owned by the user. For example, the model information may include a model number of the fourth external electronic device 117. For example, the model information may include a model name and/or a product classification group of the fourth external electronic device 117. For example, the second electronic device 103 may transmit the cooking information received from the first electronic device 101 to external electronic devices included in the second list 250.

As described above, according to an embodiment, the second electronic device 103 may store the first list 240 including information associated with the first electronic device 101. The second electronic device 103 may store the second list 250 including information associated with the second external electronic device 113 and/or information associated with the fourth external electronic device 117. The second electronic device 103 may identify whether to transmit cooking information based on the lists. The second electronic device 103 may transmit the cooking information to an external electronic device such as an HMD and/or a mobile phone terminal based on the lists, and the external electronic device may transmit the cooking information to a home appliance such as an oven. By performing the operations, convenience may be provided to a user of the external electronic device.

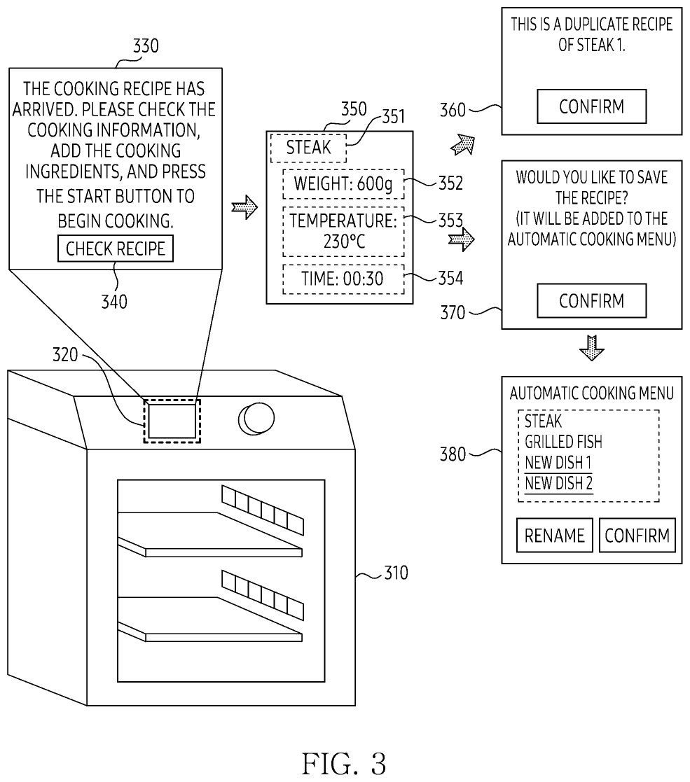

FIG. 3 illustrates an example of a user interface (UI) provided by one of electronic devices according to an embodiment. A first external electronic device 111, a second external electronic device 113, a third external electronic device 115, and/or a fourth external electronic device 117 may be referred to as a user terminal. In an example of FIG. 3, a user terminal 310 may include a home appliance such as an oven.

Referring to FIG. 3, according to an embodiment, the user terminal 310 may include a display 320. For example, the display 320 may be referred to as the display 150 of FIG. 1B. According to an embodiment, the user terminal 310 may receive cooking information from an electronic device (e.g., a first electronic device 101 and a second electronic device 103) such as a server. For example, the user terminal 310 may receive a signal including the cooking information. The user terminal 310 may display a first screen 330 for notifying reception of the cooking information in response to the reception of the cooking information. For example, the user terminal 310 may display the first screen 330 for notifying the reception of the signal including the cooking information in response to the reception of the signal including the cooking information. For example, the user terminal 310 may display, in the first screen 330, text such as ‘The cooking recipe has arrived. Please check the cooking information, add the cooking ingredients, and press the start button to begin cooking’. For example, the start button may include a physical button disposed in a housing of the user terminal 310.

According to an embodiment, the user terminal 310 may display a button 340 including text such as ‘Check Recipe’ and configured to check the cooking information. For example, the user terminal 310 may display the button 340 including an image and configured to check the cooking information. However, it is not limited thereto.

According to an embodiment, the user terminal 310 may identify an input for the button 340 configured to check the cooking information. For example, the user terminal 310 may display a second screen 350 including the cooking information based on the input for the button 340. For example, the second screen 350 may include information such as a dish name 351, weight of ingredients 352, a temperature to be cooked 353, and/or a time to be cooked 354. For example, the user terminal 310 may display information such as the dish name 351, the weight of ingredient 352, the temperature to be cooked 353, and/or the time to be cooked 354. The user terminal 310 may display the information using text. Although not illustrated, a button for storing the cooking information may be included in the second screen 350.

According to an embodiment, the user terminal 310 may identify whether the cooking information transmitted from an external electronic device is stored in a memory based on an input for the button for storing the cooking information. For example, the user terminal 310 may identify whether there is information matching the cooking information transmitted from the external electronic device based on a list in the memory. The user terminal 310 may display a third screen 360 based on first cooking information in the list matching second cooking information transmitted from the external electronic device. For example, the third screen 360 may be displayed when there is cooking information substantially identical to the cooking information transmitted from the external electronic device in the user terminal 310.

For example, the user terminal 310 may display a fourth screen 370 based on the first cooking information in the list not matching the second cooking information transmitted from the external electronic device. For example, the fourth screen 370 may include a screen for determining whether to store the second cooking information transmitted from the external electronic device. For example, the fourth screen 370 may include text such as ‘Would you like to save the recipe? It will be added to the automatic cooking menu’. For example, the recipe may be substantially identical to the cooking information. For example, the automatic cooking menu may include a list for performing a preset operation based on a preset input.

For example, the user terminal 310 may display a fifth screen 380 based on an input for storing the cooking information. For example, the user terminal 310 may display the fifth screen 380 based on one or more data sets. For example, the one or more data sets may correspond to the cooking information. For example, when new cooking information is added, the user terminal 310 may display an underline on text representing the new cooking information. The user terminal 310 may include a button for changing the name of the cooking information.

As described above, according to an embodiment, the user terminal 310 may receive cooking information transmitted from an external electronic device. The user terminal 310 may perform an operation using the cooking information based on receiving the cooking information. The user terminal 310 may store the cooking information. The user terminal 310 may provide convenience to users of the user terminal 310 by receiving the cooking information from the external electronic device and performing an operation based on the cooking information.

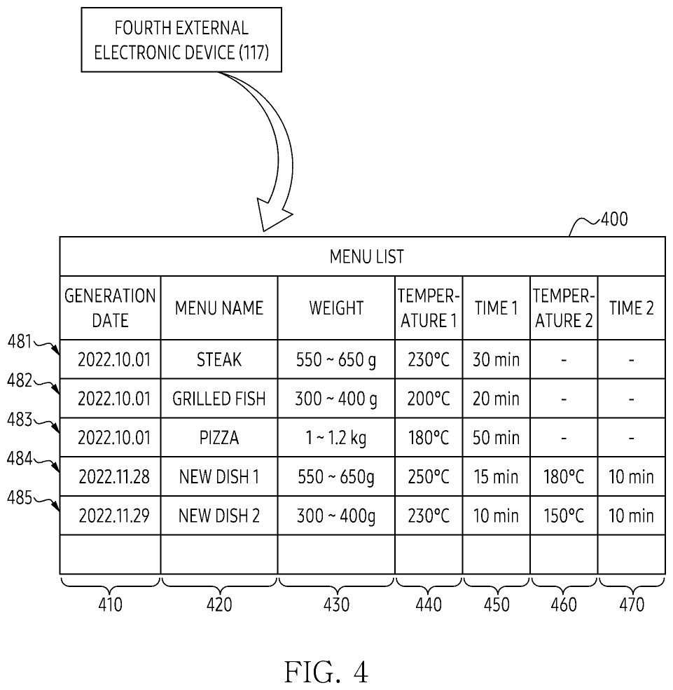

FIG. 4 illustrates an example of information stored in a memory included in one of electronic devices according to an embodiment.

Referring to FIG. 4, according to an embodiment, a fourth external electronic device 117 may store a menu list 400 including a plurality of data sets associated with cooking information in the memory. For example, the menu list 400 may include the automatic cooking menu described in FIG. 3. In FIG. 4, although the fourth external electronic device 117 is illustrated, the second external electronic device 115 may perform the operations of FIG. 4. For example, the fourth external electronic device 117 may be referred to as the user terminal 310 of FIG. 3.

For example, the menu list 400 may include a first column 410 for indicating a date on which the cooking information was generated. For example, the date on which the cooking information was generated may include a date on which the cooking information transmitted from an electronic device (e.g., a first electronic device 101 and a second electronic device 103) was stored.

For example, the menu list 400 may include a second column 420 for indicating a name of the cooking information. For example, the name of the cooking information may be set by a user of the fourth external electronic device 117. For example, the name of the cooking information may be set by a user of a device that transmitted the cooking information.

For example, the menu list 400 may include a third column 430 for indicating weight of food ingredients. For example, the weight of the food ingredients may be set by the user of the device that transmitted the cooking information. For example, the weight of the food ingredients may be represented based on an international system of units, such as international system units (SI), a yard-pound system, and/or the US customary units.

For example, the menu list 400 may include a fifth column 450 for indicating a temperature to be operated by being set as a first temperature. For example, the menu list 400 may include a sixth column 460 for indicating a time to be operated by being set as a first time. For example, the fourth external electronic device 117 may operate for the first time identified in the sixth column 460 based on the first temperature identified in the fifth column 450.

For example, the menu list 400 may include a seventh column 470 for indicating a temperature to be operated by being set as a second temperature. For example, the menu list 400 may include an eighth column 480 for indicating a time to be operated by being set as a second time. For example, the fourth external electronic device 117 may operate for the second time identified in the eighth column 480 based on the second temperature identified in the seventh column 470. For example, the fourth external electronic device 117 may operate for the first time based on the first temperature and for the second time based on the second temperature.

For example, the menu list 400 may include a first row 481 for indicating a first data set corresponding to first cooking information. For example, the menu list 400 may include a second row 482 for indicating a second data set corresponding to second cooking information. For example, the menu list 400 may include a third row 483 for indicating a third data set corresponding to third cooking information. For example, the menu list 400 may include a fourth row 484 for indicating a fourth data set corresponding to fourth cooking information. For example, the menu list 400 may include a fifth row 485 for indicating a fifth data set corresponding to fifth cooking information. Although cooking information corresponding to each of the five data sets is illustrated in FIG. 4, but it is not limited thereto.

According to an embodiment, the fourth external electronic device 117 may identify an input selecting one of the data sets included in the menu list 400. The fourth external electronic device 117 may identify cooking information corresponding to the input based on the input. The fourth external electronic device 117 may identify data corresponding to the cooking information based on identifying the cooking information corresponding to the input. The fourth external electronic device 117 may perform an operation based on the data.

As described above, according to an embodiment, the fourth external electronic device 117 may store the menu list 400 including cooking information transmitted from an external electronic device (e.g., a first external electronic device 111 and the third external electronic device 115) through the electronic device (e.g., the first electronic device 101 and the second electronic device 103). The fourth external electronic device 117 may perform an operation corresponding to a data set based on the data set (or data) included in the menu list 400. The fourth external electronic device 117 may enhance user convenience by performing the operation corresponding to the data set.

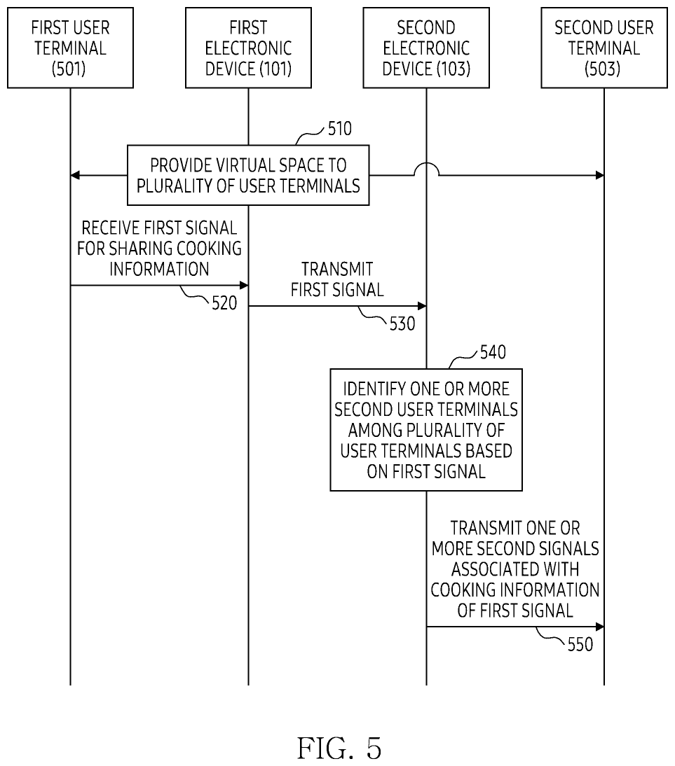

FIG. 5 illustrates an example of a signal flowchart of a network system according to an embodiment. A first electronic device 101 of FIG. 5 may include the first electronic device 101 of FIG. 1B, FIG. 1C, and/or FIG. 1D. A second electronic device 103 of FIG. 5 may include the second electronic device 103 of FIG. 1B, FIG. 1C, and/or FIG. 1D. A first user terminal 501 of FIG. 5 may include the first external electronic device 111 and/or the third external electronic device 115 of FIG. 1B, FIG. 1C, and/or FIG. 1D. A second user terminal 502 of FIG. 5 may include the second external electronic device 113 and/or the fourth external electronic device 117 of FIG. 1B, FIG. 1C, and/or FIG. 1D. A network system of FIG. 5 may include the first electronic device 101 for providing a virtual space. The network system of FIG. 5 may include the second electronic device 103 for communicating with a plurality of user terminals. The plurality of user terminals may include a first user terminal 501 and a second user terminal 503.

Referring to FIG. 5, in operation 510, according to an embodiment, the first electronic device 101 may provide a virtual space to the plurality of user terminals. For example, the virtual space may include a virtual space for providing a service such as a cooking class. For example, the virtual space may include virtual objects represented as a home appliance such as an oven.

In operation 520, according to an embodiment, the first electronic device 101 may receive a first signal for sharing cooking information from the first user terminal 501. For example, the first electronic device 101 may receive the first signal for sharing the cooking information from the first user terminal 501 among the plurality of user terminals while providing the virtual space to the plurality of user terminals. For example, the first information may include selection information for identifying one or more second user terminals selected by the first user terminal among the plurality of user terminals.

In operation 530, according to an embodiment, the first electronic device 101 may transmit the first signal to the second electronic device 103 based on receiving the first signal from the first user terminal 501. For example, the first electronic device 101 may transmit the first signal including the cooking information to the second electronic device 103.

In operation 540, according to an embodiment, the second electronic device 103 may identify one or more second user terminals 503 among the plurality of user terminals based on the first signal. For example, the second electronic device 103 may identify the one or more second user terminals 503 among the plurality of user terminals based on the selection information included in the first signal. The second electronic device 103 may transmit one or more second signals associated with the cooking information of the first signal to the one or more second user terminals 503 identified based on the selection information.

For example, the second electronic device 103 may obtain the one or more second signals for executing at least one function associated with the cooking information of the first signal, based on model information of each of the one or more second user terminals. For example, the model information may include a category of each of the one or more second user terminals 503. For example, the model information may include a model name of each of the one or more second user terminals 503. For example, the model information may include power information of each of the one or more second user terminals 503.

For example, the second electronic device 103 may change first cooking information included in the first signal to second cooking information to control each of the one or more second user terminals 503. For example, the second electronic device 103 may receive capability information of each of the one or more second user terminals 503. The second electronic device 103 may change the first cooking information to second cooking information based on the capability information of each of the one or more second user terminals 503. For example, the first cooking information and/or the second cooking information described above may be included in the second signal and transmitted to each of the one or more second user terminals 503.

For example, the one or more second user terminals 503 may perform an operation based on cooking information (e.g., the first cooking information and the second cooking information) included in the second signal.

As described above, according to an embodiment, a network system may include one or more electronic devices (e.g., the first electronic device 101 and the second electronic device 103) corresponding to a server. The network system may include a plurality of user terminals (e.g., the first user terminal 501 and the second user terminals 503). The network system may transmit a first signal, which is transmitted from the first user terminal 501 and includes cooking information, to each of the one or more second user terminals 503 through the electronic devices. The network system may increase the convenience of users of the one or more second user terminals 503 by performing the operations. The network system may provide assistance in easily sharing a cooking recipe between users of the one or more second user terminals 503 and the first user terminal 501 by performing the operations.

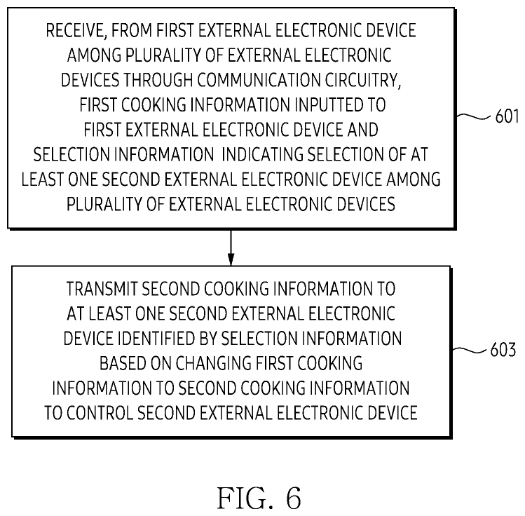

FIG. 6 illustrates an example of a flowchart of an operation of an electronic device according to an embodiment. The electronic device of FIG. 6 may include the second electronic device 103 of FIG. 1B, FIG. 1C, and/or FIG. 1D.

Referring to FIG. 6, in operation 601, according to an embodiment, an electronic device may receive first cooking information and selection information from a first external electronic device among a plurality of external electronic devices through communication circuitry (e.g., the communication circuitry 140 of FIG. 1B). For example, the first external electronic device may include the first external electronic device 111 and/or the third external electronic device 115 of FIG. 1B, FIG. 1C, and/or FIG. 1D. For example, the electronic device may receive the first cooking information inputted to the first external electronic device. For example, the electronic device may receive selection information indicating selection of at least one second external electronic device among the plurality of external electronic devices. For example, the second external electronic device may include the second external electronic device 113 and/or the fourth external electronic device 117 of FIG. 1B, FIG. 1C, and/or FIG. 1D. For example, the electronic device may receive, from the first external electronic device among the plurality of external electronic devices through the communication circuitry, the first cooking information inputted to the first external electronic device and the selection information indicating the selection of the at least one second external electronic device among the plurality of external electronic devices.

In operation 603, according to an embodiment, the electronic device may change the first cooking information. For example, the electronic device may receive capability information of the at least one second external electronic device from the at least one second external electronic device. The electronic device may change the first cooking information to second cooking information based on the capability information.

According to an embodiment, the electronic device may receive model information of the at least one second external electronic device from the at least one second external electronic device. For example, the model information may include a model name corresponding to the at least one second external electronic device. For example, the model information may include a model number of the at least one second external electronic device. For example, the model information may include a category of the at least one second external electronic device. For example, the electronic device may change the first cooking information to the second cooking information based on the model information.

For example, the electronic device may receive state information associated with an operation of the at least one second external electronic device from the at least one second external electronic device. For example, the electronic device may identify whether to transmit the second cooking information to the at least one second external electronic device based on the state information. For example, the state information may be associated with whether the second external electronic device is operating. For example, the state information may include a first state in which the second external electronic device is operating and/or a second state different from the first state. For example, the electronic device may at least temporarily cease transmission of the second cooking information based on identifying the second external electronic device in the first state. For example, the electronic device may transmit the second cooking information to the second external electronic device based on identifying the second external electronic device changed from the first state to the second state. For example, the electronic device may transmit the second cooking information to the second external electronic device identified as being in the second state. For example, the electronic device may transmit the second cooking information to the second external electronic device based on identifying the second external electronic device in the second state.

According to an embodiment, the electronic device may store data indicating a name of the first external electronic device (e.g., a first electronic device 101) for providing a virtual space in a memory. For example, the electronic device may store data indicating a code corresponding to the first external electronic device in the memory. For example, the electronic device may store data indicating an IP address corresponding to the first external electronic device. For example, the electronic device may identify whether to transmit information (or a signal) transmitted from the first external electronic device to external electronic devices different from the first external electronic device, based on the data.

For example, the electronic device may transmit the second cooking information to the at least one second external electronic device identified by the selection information based on changing the first cooking information to the second cooking information to control the second external electronic device.

As described above, according to an embodiment, the electronic device may transmit cooking information received from a first external electronic device to a second external electronic device among a plurality of external electronic devices. The electronic device may identify at least one second external electronic device to which the cooking information is to be transmitted based on selection information transmitted from the first external electronic device. The electronic device may change first cooking information received from the first external electronic device to second cooking information based on the second external electronic device. For example, the electronic device may obtain the second cooking information for the second external electronic device to perform substantially the same operation as the operation of the first external electronic device. The electronic device may transmit the second cooking information to the at least one second external electronic device identified based on the selection information. The electronic device may provide convenience of the second external electronic device by transmitting the second cooking information to the second external electronic device selected by the first external electronic device.

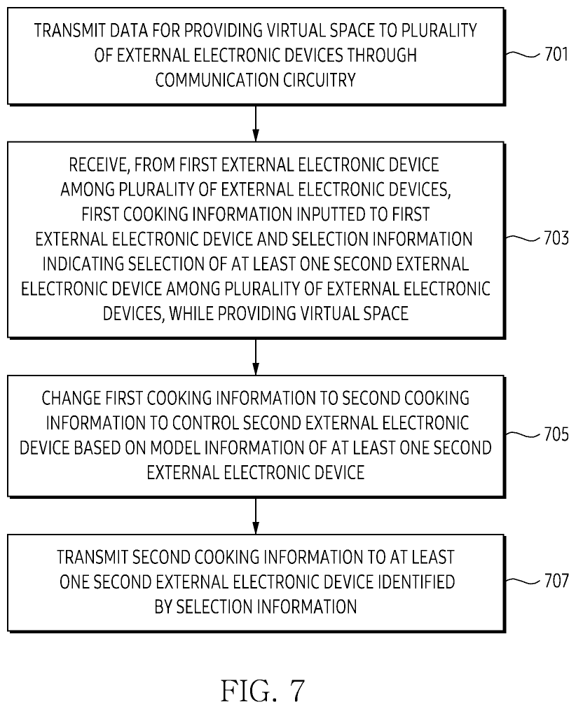

FIG. 7 illustrates an example of a flowchart of an operation of an electronic device according to an embodiment. The electronic device of FIG. 7 may include the first electronic device 101 of FIG. 1B, FIG. 1C, and/or FIG. 1D.

Referring to FIG. 7, in operation 701, according to an embodiment, an electronic device may transmit data for providing a virtual space to a plurality of external electronic devices (e.g., the second electronic device 103, the first external electronic device 101, and the second external electronic device 113 of FIGS. 1B to 1C) through communication circuitry. For example, the virtual space may include a virtual space for providing a service such as a cooking class.

In operation 703, according to an embodiment, the electronic device may receive first cooking information inputted to a first external electronic device from the first external electronic device (e.g., the first external electronic device 111 and/or the third external electronic device 113 of FIG. 1B, FIG. 1C, and/or FIG. 1D) while providing the virtual space. For example, the electronic device may receive selection information indicating selection of at least one second external electronic device among the plurality of external electronic devices while providing the virtual space. For example, the selection information may include the at least one second external electronic device, among the plurality of external electronic devices, selected by the first external electronic device. For example, while providing the virtual space, the electronic device may receive, from the first external electronic device among the plurality of external electronic devices, the first cooking information inputted to the first external electronic device and the selection information indicating the selection of the at least one second external electronic device among the plurality of external electronic devices.

In operation 705, according to an embodiment, the electronic device may receive model information of the at least one second external electronic device. For example, the model information may include a model name of the at least one second external electronic device. For example, the model information may include a model number of the at least one second external electronic device. For example, the model information may include a category of the at least one second external electronic device. For example, the electronic device may store the model information in a memory. The electronic device may change the first cooking information to second cooking information to control the second external electronic device based on the model information of the at least one second external electronic device.

For example, the electronic device may receive capability information associated with the at least one second external electronic device from the at least one second external electronic device. For example, the capability information may include power information. For example, the capability information may include functions provided by the at least one second external electronic device. The electronic device may change the first cooking information to the second cooking information based on the capability information of the at least one second external electronic device. For example, the electronic device may change the first cooking information to the second cooking information to obtain a dish substantially identical to a dish cooked by the first external electronic device. For example, the electronic device may change the first cooking information to the second cooking information to control the second external electronic device based on the model information of the at least one second external electronic device.

In operation 707, according to an embodiment, the electronic device may identify the at least one second external electronic device based on the selection information. For example, the electronic device may transmit the second cooking information to the at least one second external electronic device identified by the selection information.

For example, the electronic device may receive state information associated with an operation of the at least one second external electronic device from the at least one second external electronic device. For example, the state information may include a first state in which the second external electronic device is operating and/or a second state different from the first state. The electronic device may identify whether to transmit the second cooking information to the second external electronic device based on the state information. For example, the electronic device may identify a second external electronic device in the first state based on the state information. The electronic device may at least temporarily cease transmission of the second cooking information based on identifying the second external electronic device in the first state. For example, the electronic device may identify a second external electronic device in the second state based on the state information. The electronic device may transmit the second cooking information to the second external electronic device based on identifying the second external electronic device in the second state.

As described above, according to an embodiment, the electronic device may receive first cooking information and selection information from a first external electronic device. The electronic device may receive state information and/or capability information of a second external electronic device from the second external electronic device. The electronic device may change the first cooking information to second cooking information based on the state information and/or the capability information. The electronic device may selectively transmit the changed second cooking information to at least one second external electronic device based on the selection information. For example, the electronic device may obtain the second cooking information for the second external electronic device to perform substantially the same operation as an operation of the first external electronic device. The electronic device may provide convenience to a user of the at least one second external electronic device by transmitting the second cooking information to the at least one second external electronic device.

A method for changing first cooking information transmitted from a first external electronic device and transmitting it to a second external electronic device may be required. As described above, according to an embodiment, a network system may include a virtual space server 101 for providing a virtual space, and an IoT server 103 for communicating with a first user terminal 111, 115, or 501. The virtual space server 101 may receive a first signal for sharing cooking information from the first user terminal 111, 115, or 501 while providing the virtual space 100 to the first user terminal 111, 115, or 501. The virtual space server 101 may transmit the first signal to the IoT server based on receiving the first signal. The IoT server 103 may transmit one or more second signals associated with the cooking information of the first signal to one or more second user terminals 113, 117, and 503 different from the first user terminal 111, 115, or 501.

According to an embodiment, the IoT server 103 may obtain, based on model information of each of the one or more second user terminals 113, 117, and 503, the one or more second signals for executing at least one function associated with the cooking information of the first signal.

According to an embodiment, the model information may include at least one of a category of each of the one or more second user terminals 113, 117, and 503, a model name of each of the one or more second user terminals 113, 117, and 503, and power information of each of the one or more second user terminals 113, 117, and 503.

According to an embodiment, the first signal may include selection information for identifying the one or more second user terminals 113, 117, and 503 selected by the first user terminal 111, 115, or 501.

According to an embodiment, the cooking information may be first cooking information. The second electronic device 103 may change the first cooking information to second cooking information to control each of the one or more second user terminals 113, 117, and 503.

According to an embodiment, the IoT server 103 may receive capability information of each of the one or more second user terminals 113, 117, and 503. The IoT server 103 may change the first cooking information to the second cooking information based on the capability information.

According to an embodiment, the cooking information may include at least one of a cooking name, weight of food ingredients, a cooking temperature, and a cooking time.

As described above, according to an embodiment, an electronic device 103 may comprise communication circuitry 140 and a processor 120. The processor 120 may receive, from a first external electronic device 111 or 115 among a plurality of external electronic devices 111, 113, 115, and 117 through the communication circuitry 140, selection information including first cooking information inputted to the first external electronic device 111 or 115 and indicating selection of at least one second external electronic device 113 or 117 among the plurality of external electronic devices. The processor 120 may transmit, based on changing the first cooking information to second cooking information to control the second external electronic device 113 or 117, the second cooking information to the at least one second external electronic device 113 or 117 identified by the selection information.

According to an embodiment, the processor 120 may receive, from the at least one second external electronic device 113 or 117, capability information of the at least one second external electronic device 113 or 117. The processor 120 may change, based on the capability information, the first cooking information to the second cooking information.

According to an embodiment, the processor 120 may receive, from the at least one second external electronic device 113 or 117, state information associated with an operation of the at least one second external electronic device 113 or 117. The processor 120 may identify, based on the state information, whether to transmit the second cooking information.

According to an embodiment, the processor 120 may receive, from the at least one second external electronic device 113 or 117, model information of the at least one second external electronic device 113 or 117. The processor 120 may change, based on the model information, the first cooking information to the second cooking information. The processor 120 may transmit the second cooking information to the at least one second external electronic device 113 or 117.

According to an embodiment, the model information may include at least one of a model name of the at least one second external electronic device 113 or 117, a model number of the at least one second external electronic device 113 or117, and a category of the at least one second external electronic device 113 or 117.

According to an embodiment, the electronic device 103 may include a memory 130. The processor 120 may store, in the memory 130, data including at least one of a name, a code, and an internet protocol (IP) address of the first external electronic device 101 to provide a virtual space 100.

As described above, according to an embodiment, an electronic device 101 may comprise communication circuitry 140 and a processor 120. The processor 120 may transmit data for providing a virtual space 100 to a plurality of external electronic devices 103, 111, 113, 115, and 117 through the communication circuitry 140. While providing the virtual space 100, the processor 120 may receive, from a first external electronic device 111 or 113 among the plurality of external electronic devices 103, 111, 113, 115, and 117, selection information including first cooking information inputted to the first external electronic device 111 or 113 and indicating selection of at least one second external electronic device 113 or 115 among the plurality of external electronic devices 103, 111, 113, 115, and 117. The processor 120 may change, based on model information of the at least one second external electronic device 113 or 115, the first cooking information to second cooking information to control the second external electronic device 113 or 115. The processor 120 may transmit the second cooking information to the at least one second external electronic device 113 or 115 identified by the selection information.

According to an embodiment, the model information may include at least one of a model name of the at least one second external electronic device 113 or 115, a model number of the at least one second external electronic device 113 or 115, and a category of the at least one second external electronic device 113 or 115.

According to an embodiment, the electronic device 101 may comprise a memory 130. The processor 120 may store the model information in the memory 130.

According to an embodiment, the processor 120 may receive, from the at least one second external electronic device 113 or 115, state information associated with an operation of the at least one second external electronic device 113 or 115. The processor 120 may identify, based on the state information, whether to transmit the second cooking information.

According to an embodiment, the processor 120 may receive, from the at least one second external electronic device 113 or 115, capability information of the at least one second external electronic device 113 or 115. The processor 120 may change, based on the capability information, the first cooking information to the second cooking information.

According to an embodiment, the processor may be configured to generate the second cooking information by changing a cooking time included in the first cooking information using output of the at least one second external electronic device indicated by the capability information.

According to an embodiment, the capability information may include at least one of power information of the at least one second external electronic device 113 or 115 and functions provided by the at least one second external electronic device 113 or 115.

According to an embodiment, the processor 120 may display a virtual object for inputting the first cooking information in the virtual space 100.

As described above, according to an embodiment, in a method of a network system, the network system may include a first electronic device 101 for providing a virtual space and a second electronic device 103 for communicating with a plurality of user terminals 111, 113, 115, and 117.

The method may include transmitting a first signal for sharing cooking information to the first electronic device 101 from a first user terminal 111, 115, or 501 among the plurality of user terminals 111, 113, 115, and 117 while providing the virtual space 100 to the plurality of user terminals 111, 113, 115, and 117. The method may include transmitting the first signal to the second electronic device based on the first electronic device 101 receiving the first signal. The method may include transmitting, from the second electronic device 103, one or more second signals associated with the cooking information of the first signal to one or more second user terminals 113, 117, and 503 identified among the plurality of user terminals 111, 113, 115, and 117 based on the first signal.

According to an embodiment, the method may include obtaining, by the second electronic device 103, based on model information of each of the one or more second user terminals 113, 117, and 503, the one or more second signals for executing at least one function associated with the cooking information of the first signal.

According to an embodiment, the model information may include at least one of a category of each of the one or more second user terminals 113, 117, and 503, a model name of each of the one or more second user terminals 113, 117, and 503, and power information of each of the one or more second user terminals 113, 117, and 503.

According to an embodiment, the first signal may include selection information for identifying the one or more second user terminals 113, 117, and 503 selected by the first user terminal 111, 115, or 501.

According to an embodiment, the cooking information may be first cooking information. The method may include the second electronic device 103 changing the first cooking information to second cooking information to control each of the one or more second user terminals 113, 117, and 503.

According to an embodiment, the method may include the second electronic device 103 receiving capability information of each of the one or more second user terminals 113, 117, and 503. The method may include the electronic device 103 changing the first cooking information to the second cooking information based on the capability information.

According to an embodiment, the cooking information may include at least one of a cooking name, weight of food ingredients, a cooking temperature, and a cooking time.

As described above, according to an embodiment, a method of an electronic device 103 may include receiving, from a first external electronic device 111 or 115 among a plurality of external electronic devices 111, 113, 115, and 117 through communication circuitry 140, selection information including first cooking information inputted to the first external electronic device 111 or 115 and indicating selection of at least one second external electronic device 113 or 117 among the plurality of external electronic devices. The method may include transmitting, based on changing the first cooking information to second cooking information to control the second external electronic device 113 or 117, the second cooking information to the at least one second external electronic device 113 or 117 identified by the selection information.

According to an embodiment, the method may comprise receiving, from the at least one second external electronic device 113 or 117, capability information of the at least one second external electronic device 113 or 117. The method may comprise changing, based on the capability information, the first cooking information to the second cooking information.

According to an embodiment, the method may comprise receiving, from the at least one second external electronic device 113 or 117, state information associated with an operation of the at least one second external electronic device 113 or 117. The method may comprise, based on the state information, identifying whether to transmit the second cooking information.

According to an embodiment, the method may comprise receiving, from the at least one second external electronic device 113 or 117, model information of the at least one second external electronic device 113 or 117. The method may comprise changing, based on the model information, the first cooking information to the second cooking information. The method may comprise transmitting the second cooking information to the at least one second external electronic device 113 or 117.

According to an embodiment, the model information may include at least one of a model name of the at least one second external electronic device 113 or 117, a model number of the at least one second external electronic device 113 or 117, and a category of the at least one second external electronic device 113 or 117.

According to an embodiment, the electronic device 103 may comprise a memory 130. The processor 120 may store, in the memory 130, data including at least one of a name, a code, and an internet protocol (IP) address of the first external electronic device 101 to provide a virtual space 100.

As described above, according to an embodiment, in a method of an electronic device 101, the method may comprise transmitting data for providing a virtual space 100 to a plurality of external electronic devices 103, 111, 113, 115, and 117 through communication circuitry 140. While providing the virtual space 100, the method may comprise receiving, from a first external electronic device 111 or 113 among the plurality of external electronic devices 103, 111, 113, 115, and 117, selection information including first cooking information inputted to the first external electronic device 111 or 113 and indicating selection of at least one second external electronic device 113 or 115 among the plurality of external electronic devices 103, 111, 113, 115, and 117. The method may comprise changing, based on model information of the at least one second external electronic device 113 or 115, the first cooking information to second cooking information to control the second external electronic device 113 or 115. The method may comprise transmitting the second cooking information to the at least one second external electronic device 113 or 115 identified by the selection information.

According to an embodiment, the model information may include at least one of a model name of the at least one second external electronic device 113 or 115, a model number of the at least one second external electronic device 113 or 115, and a category of the at least one second external electronic device 113 or 115.

According to an embodiment, the method may comprise storing, in a memory 130, the model information.

According to an embodiment, the method may comprise receiving, from the at least one second external electronic device 113 or 115, state information associated with an operation of the at least one second external electronic device 113 or 115. The method may comprise identifying, based on the state information, whether to transmit the second cooking information.

According to an embodiment, the method may comprise receiving, from the at least one second external electronic device 113 or 115, capability information of the at least one second external electronic device 113 or 115. The method may comprise changing, based on the capability information, the first cooking information to the second cooking information.

According to an embodiment, the capability information may include at least one of power information of the at least one second external electronic device 113 or 115 and functions provided by the at least one second external electronic device 113 or 115.

According to an embodiment, the method may comprise displaying a virtual object for inputting the first cooking information in the virtual space 100.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the first electronic device 101, the second electronic device 103, the first external electronic device 111, the second external electronic device 113, the third external electronic device 115, and the fourth external electronic device 117). For example, a processor (e.g., the processor 120) of the machine (e.g., the first electronic device 101, the second electronic device 103, the first external electronic device 111, the second external electronic device 113, the third external electronic device 115, and the fourth external electronic device 117) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
a communication circuitry; and
a processor configured to:
receive, from a first external electronic device among a plurality of external electronic devices through the communication circuitry, selection information including first cooking information inputted to the first external electronic device and indication to control at least one second external electronic device selected among the plurality of external electronic devices; and
transmit, based on the first cooking information being changed to second cooking information, the second cooking information to the at least one second external electronic device based on the indication to control the at least one second external electronic device in the selection information.

2. The electronic device of claim 1, wherein the processor is configured to:
receive, from the at least one second external electronic device, capability information of the at least one second external electronic device; and
wherein the first cooking information is changed to the second cooking information based on the capability information.

3. The electronic device of claim 2, wherein the processor is configured to:
generate the second cooking information by changing a cooking time included in the first cooking information based on the capability information which is received from the at least one second external electronic device.

4. The electronic device of claim 1, wherein the processor is configured to:
receive, from the at least one second external electronic device, state information associated with an operation of the at least one second external electronic device; and
wherein the processor determines whether to transmit the second cooking information prior to the second cooking information being transmitted.

5. The electronic device of claim 1, wherein the processor is configured to:
receive, from the at least one second external electronic device, model information of the at least one second external electronic device;
wherein the first cooking information is changed to the second cooking information based on the model information; and
the second cooking information is transmitted to the at least one second external electronic device.

6. The electronic device of claim 5, wherein the model information includes at least one of a model name of the at least one second external electronic device, a model number of the at least one second external electronic device, and a category of the at least one second external electronic device.

7. The electronic device of claim 1, further comprising a memory,
wherein the processor is configured to:
store, in the memory, data including at least one of a name, a code, and an IP (internet protocol) address of the first external electronic device to provide a virtual space.

8. The electronic device of claim 1, wherein the first cooking information includes at least one of a cooking name, a weight of food ingredients, a cooking temperature, and a cooking time.

9. A method of an electronic device including communication circuitry, comprising:
receiving, from a first external electronic device among a plurality of external electronic devices through the communication circuitry, selection information including first cooking information inputted to the first external electronic device and indication to control at least one second external electronic device among the plurality of external electronic devices; and
transmitting, based on the first cooking information being changed to second cooking information, the second cooking information to the at least one second external electronic device based on the indication to control the at least one second external electronic device in the selection information.

10. The method of claim 9, further comprising:
receiving, from the at least one second external electronic device, capability information of the at least one second external electronic device; and
wherein the first cooking information is changed to the second cooking information based on the capability information.

11. The method of claim 9, wherein the transmitting the second cooking information comprising:
receiving, from the at least one second external electronic device, state information associated with an operation of the at least one second external electronic device; and
identifying, based on the state information, whether to transmit the second cooking information.

12. The method of claim 9, further comprising:
receiving, from the at least one second external electronic device, model information of the at least one second external electronic device;
wherein the first cooking information is changed to the second cooking information based on the model information; and
the second cooking information is transmitted to the at least one second external electronic device.

13. The method of claim 12, wherein the model information includes at least one of a model name of the at least one second external electronic device, a model number of the at least one second external electronic device, and a category of the at least one second external electronic device.

14. The method of claim 9, further comprising:
storing, in a memory, data including at least one of a name, a code, and an IP (internet protocol) address of the first external electronic device to provide a virtual space.

15. The method of claim 9, wherein the first cooking information includes at least one of a cooking name, a weight of food ingredients, a cooking temperature, and a cooking time.

16. A non-transitory computer readable storage medium storing instructions, executable by an electronic device including a communication circuitry, to cause the electronic device to:
receive, from a first external electronic device among a plurality of external electronic devices through the communication circuitry, selection information including first cooking information inputted to the first external electronic device and indication to control at least one second external electronic device among the plurality of external electronic devices; and
transmit, based on the first cooking information being changed to second cooking information, the second cooking information to the at least one second external electronic device based on the indication to control the at least one second external electronic device in the selection information.

17. The non-transitory computer readable storage medium of claim 16, wherein the instructions, when executed by the electronic device, cause the electronic device to:
receive, from the at least one second external electronic device, capability information of the at least one second external electronic device; and
wherein the first cooking information is changed to the second cooking information based on the capability information.

18. The non-transitory computer readable storage medium of claim 17, wherein the instructions, when executed by the electronic device, cause the electronic device to:
generate the second cooking information by changing a cooking time included in the first cooking information based on the capability information which is received the at least one second external electronic device.

19. The non-transitory computer readable storage medium of claim 16, wherein the instructions, when executed by the electronic device, cause the electronic device to:
receive, from the at least one second external electronic device, state information associated with an operation of the at least one second external electronic device; and
identify, based on the state information, whether to transmit the second cooking information.

20. The non-transitory computer readable storage medium of claim 16, wherein the instructions, when executed by the electronic device, cause the electronic device to:
receive, from the at least one second external electronic device, model information of the at least one second external electronic device;
wherein the first cooking information is changed to the second cooking information based on the model information; and
the second cooking information is transmitted to the at least one second external electronic device.
